(19) United States
(12) Patent Application Publication
(10) Pub. No.: US 2004/0181980 A1
(43) Pub. Date: Sep. 23, 2004

(54) Structure with variable geometric pattern and appearance

(76) Inventor: Chanan Gardi, Firenze (IT)

Correspondence Address: MCGLEW & TUTTLE, PC, 1 SCARBOROUGH STATION PLAZA, SCARBOROUGH, NY, 10510-0827, US

(21) Appl. No.: 10/390,409

(22) Filed: Mar. 17, 2003

(51) Int. Cl. G09F 1/10

(52) U.S. Cl. 40/124

(57) ABSTRACT

Structure with variable geometric pattern and appearance, especially, although not exclusively, for use in making stationery or publishing articles, as well as envelopes or packages, characterized in that it comprises: a first element (1) having an aperture (2) whose outline defines a preset geometric or fancy figure; a flap or patch of fabric or cloth (3) applied on the rear surface (10) of said first element (1); a second element (4) associated with the rear surface of said first element (1) on the back of said fabric (3) so that the said fabric will result interposed between the first (1) and second (4) elements, the same fabric being able to partly project from the surface defined by said first element (1) or said second element (4), the surface of the latter being either continuous or provided, likewise the surface of the first element (1), with one or more apertures.

The present invention refers to a structure with variable geometric pattern and appearance, especially, although not exclusively, for use in making stationery or publishing articles, as well as envelopes or packages.

In particular, a structure according to the invention allows making articles with which the user can interact by altering the appearance thereof, also for play or amusement. Moreover, the present structure is relatively easy and cost-effective to make, and can be used for making article of various kind such as postcards and greetings cards, calendars, covers and internal pages of books, notebooks and diaries, envelopes, lids for boxes and containers in general, key cases, cellular cases, spectacle cases, bags, belts, purses, masks and others.

This result has been achieved, according to the present invention, by adopting the idea of making an apparatus having the characteristics indicated in the claim 1. Further characteristics being set forth in the dependent claims.

In the description that follows, reference will be made to the attached drawings which are to be considered by way of non limiting example, wherein:

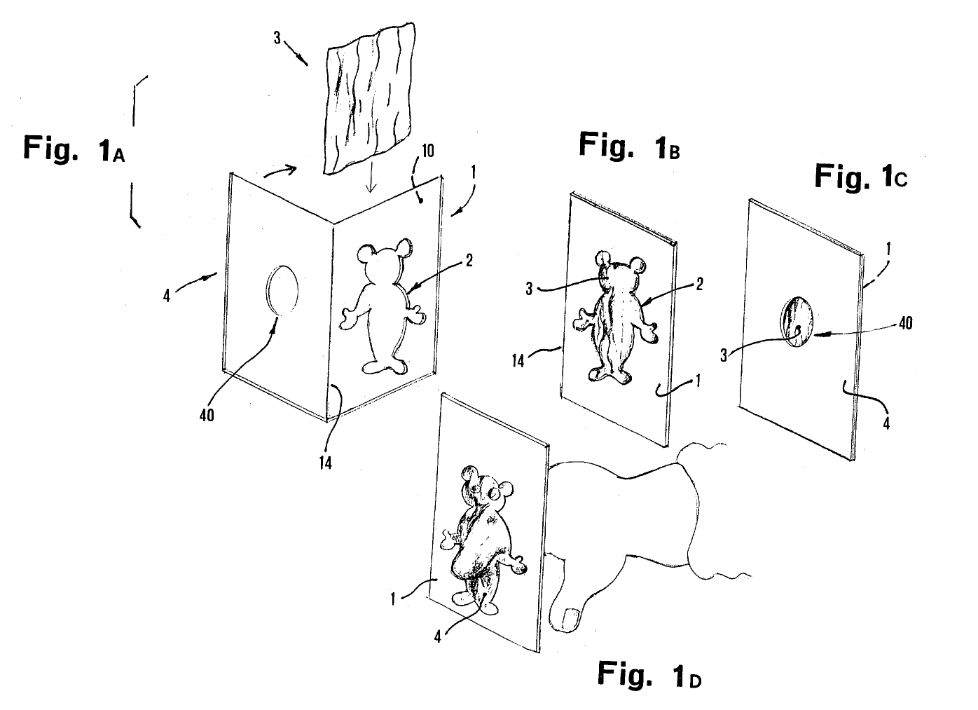

FIG. 1 is a schematic exploded perspective view of a structure, according to the present invention, intended for making up a greetings card or the like, by which it is possible to play simple animation games;

FIG. 1B is a schematic antero-lateral perspective view of the structure of FIG. 1A after the assembly thereof;

FIG. 1C is a schematic lateral-dorsal perspective view of the structure of FIG. 1A after the assembly thereof;

FIG. 1D shows the example of the preceding figures for use in a simple animation game;

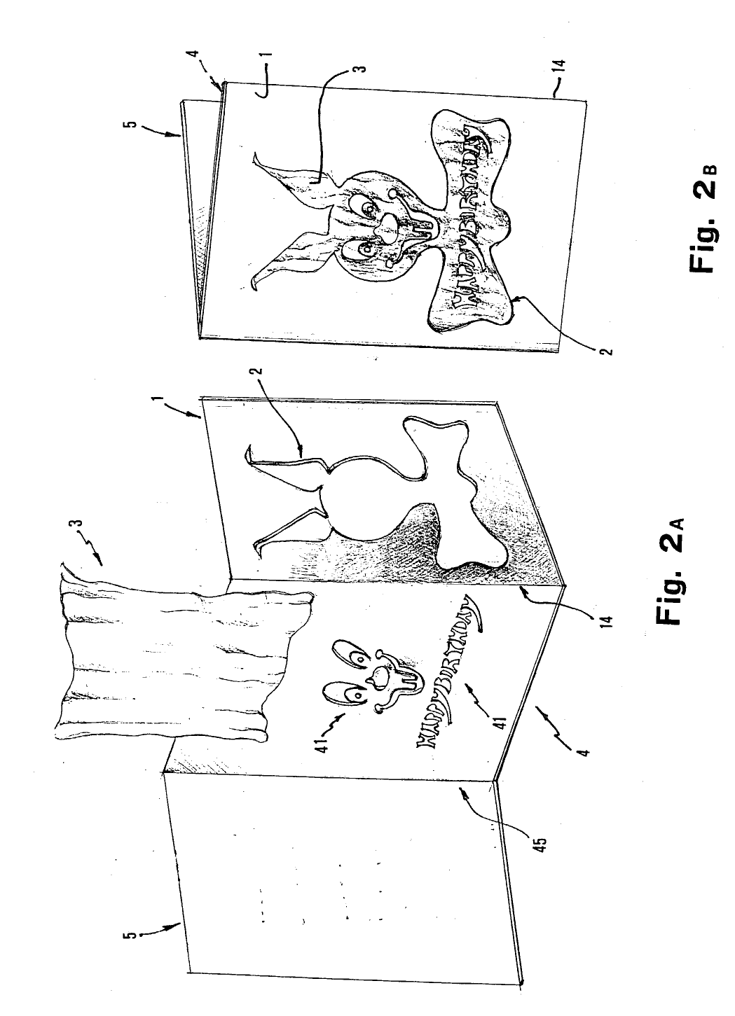

FIG. 2A shows a second embodiment and use of the structure according to the invention, in a schematic exploded perspective view;

FIG. 2B shows the object of FIG. 2A after the assembly thereof;

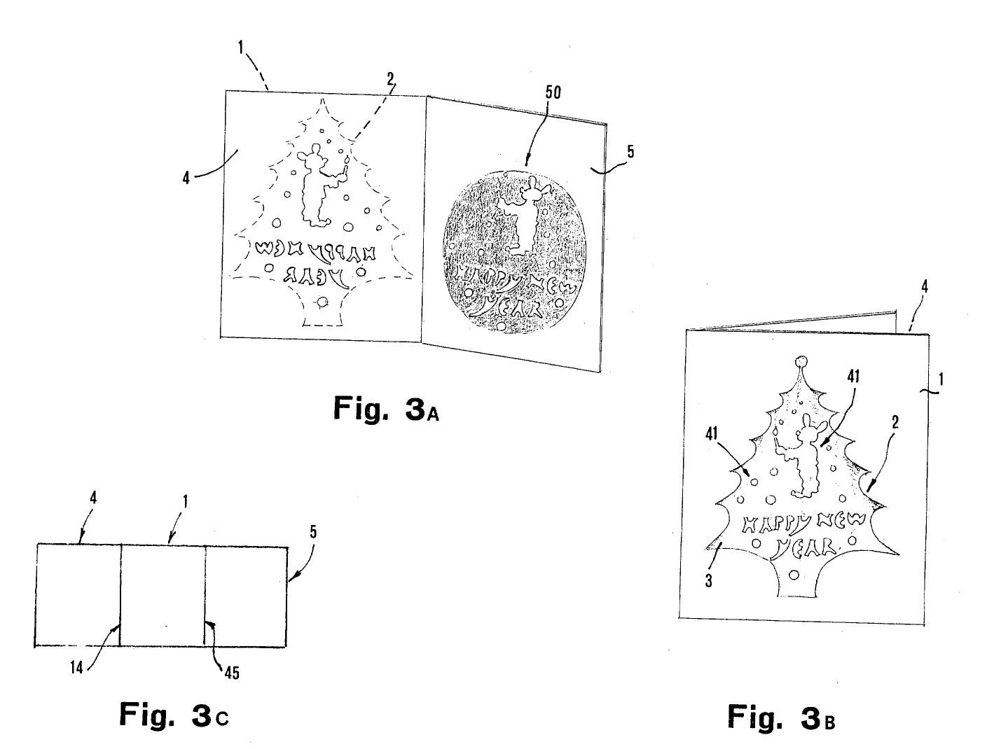

FIG. 3A is a schematic perspective view of the internal pages of a third embodiment and use of a structure according to the invention;

FIG. 3B shows schematically the object of FIG. 3A as viewed from the side of the front page or cover;

FIG. 3C shows schematically a plane development of the structure of FIGS. 3A and 3B;

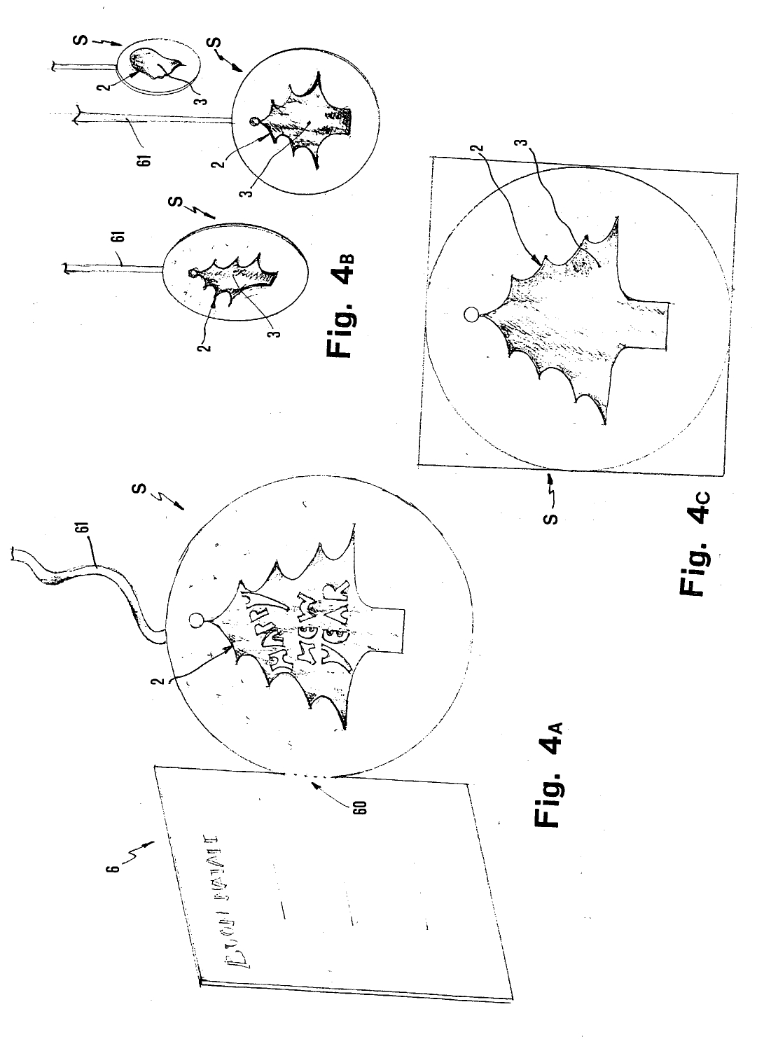

FIG. 4A is a perspective view of a fourth embodiment and use of a structure according to the invention;

FIG. 4B shows a separate element of the object of FIG. 4A;

FIG. 4C is a front view of the embodiment of FIG. 4A;

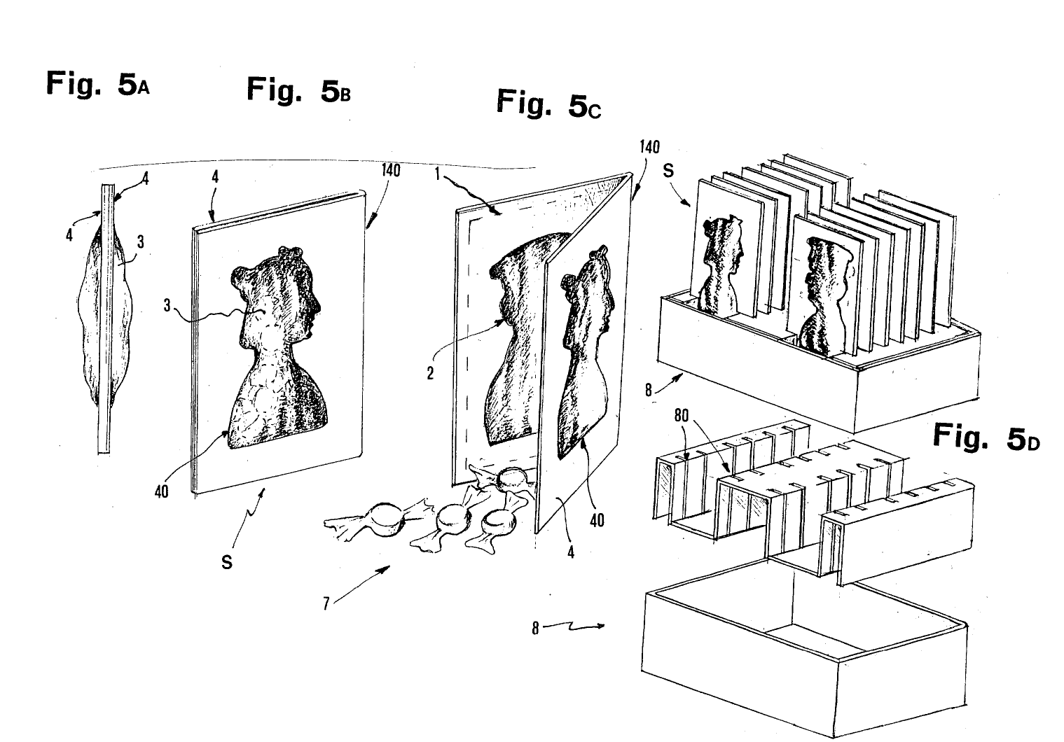

FIG. 5A shows a fifth embodiment and use of a structure according to the invention, in open configuration;

FIG. 5B is a schematic, antero-lateral perspective view of the object of FIG. 5A, in closed configuration;

FIG. 5C is a side view of the object of FIG. 5B;

FIG. 5D is a schematic exploded perspective view of a container-display stand in which more objects of the type shown in FIGS. 5B and 5C can be disposed;

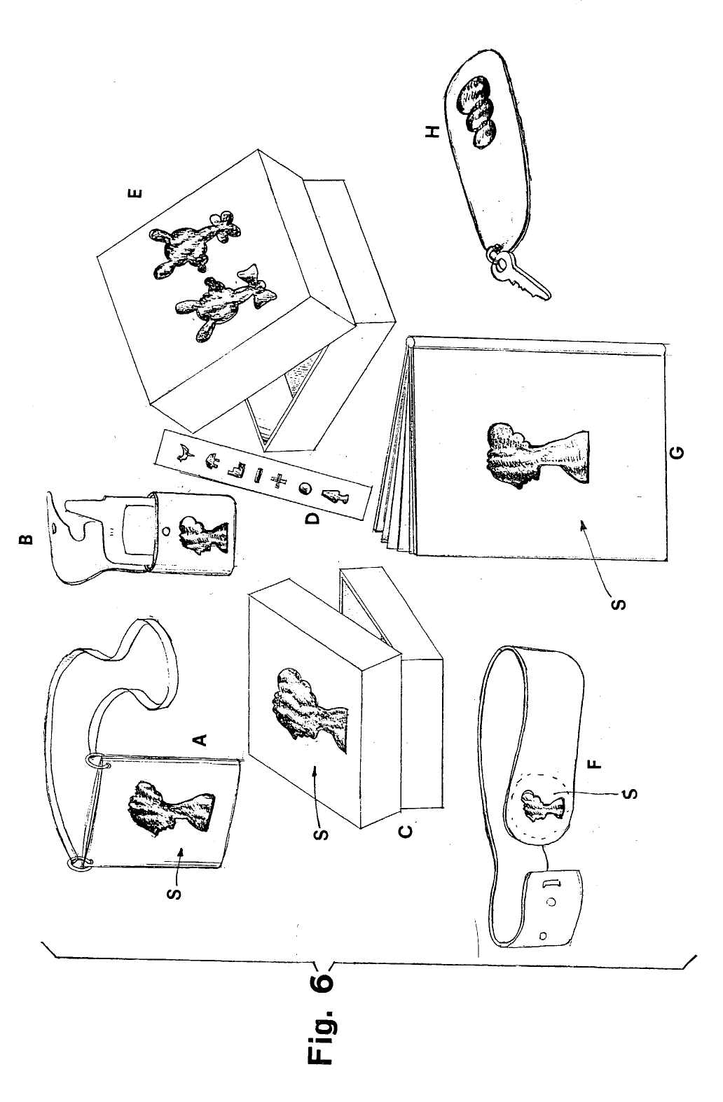

FIGS. 6A-6H show further embodiments and uses of a structure according to the invention and, in particular, a bag (FIG. 6A), a cellular case (FIG. 6B), a box (FIG. 6C), a bookmarker (FIG. 6D), a further box (FIG. 6E), a belt (FIG. 6F), a book (FIG. 6G) and a key case (FIG. 6H);

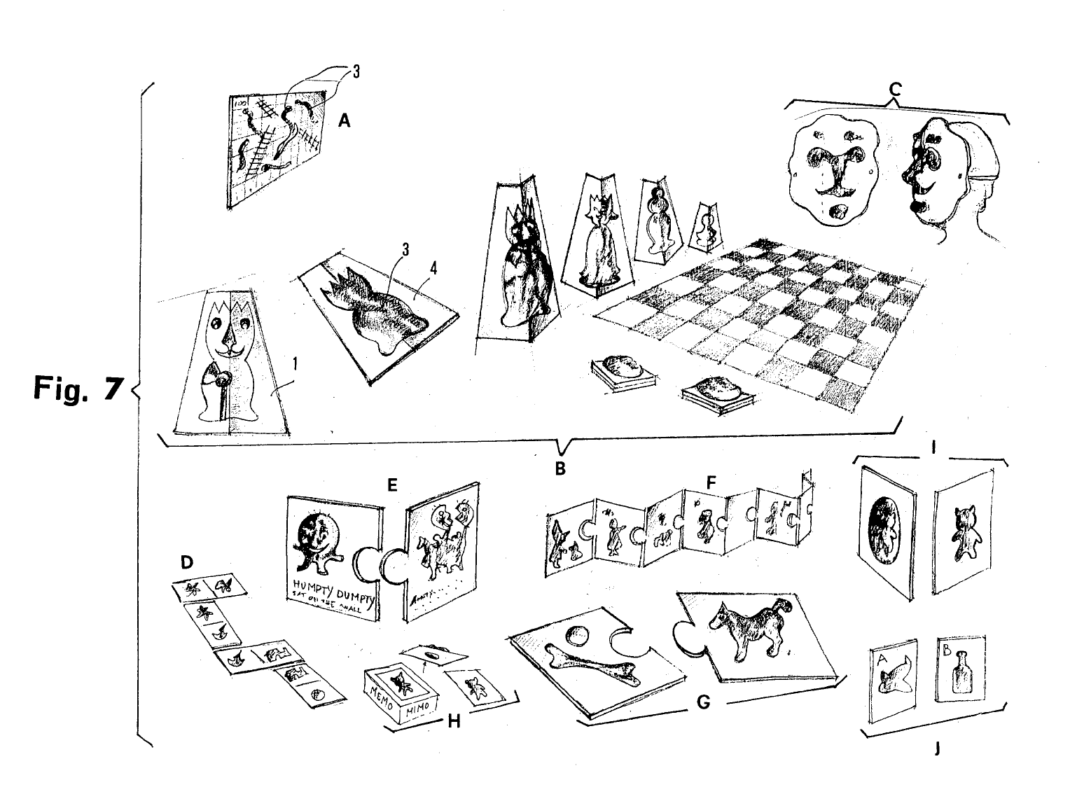

FIGS. 7A-7J show further embodiments and uses of a structure according to the invention and, in particular, a board game (FIG. 7A), a chessboard with models of chess and draught (FIG. 7B), a mask (FIG. 7C, in which the latter is shown both separate, in front view, and put on, in perspective view), some games of puzzle type (FIGS. 7E, 7F, 7G), a game with characters to be guessed (FIG. 7H) and two card games (FIGS. 7I and 7J);

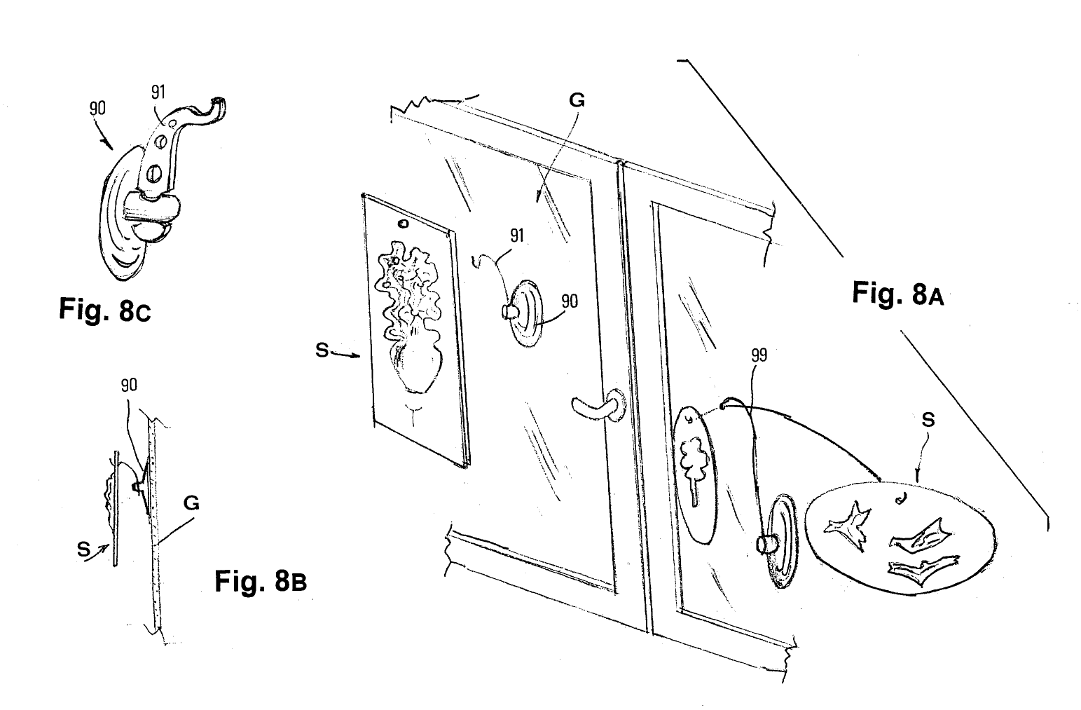

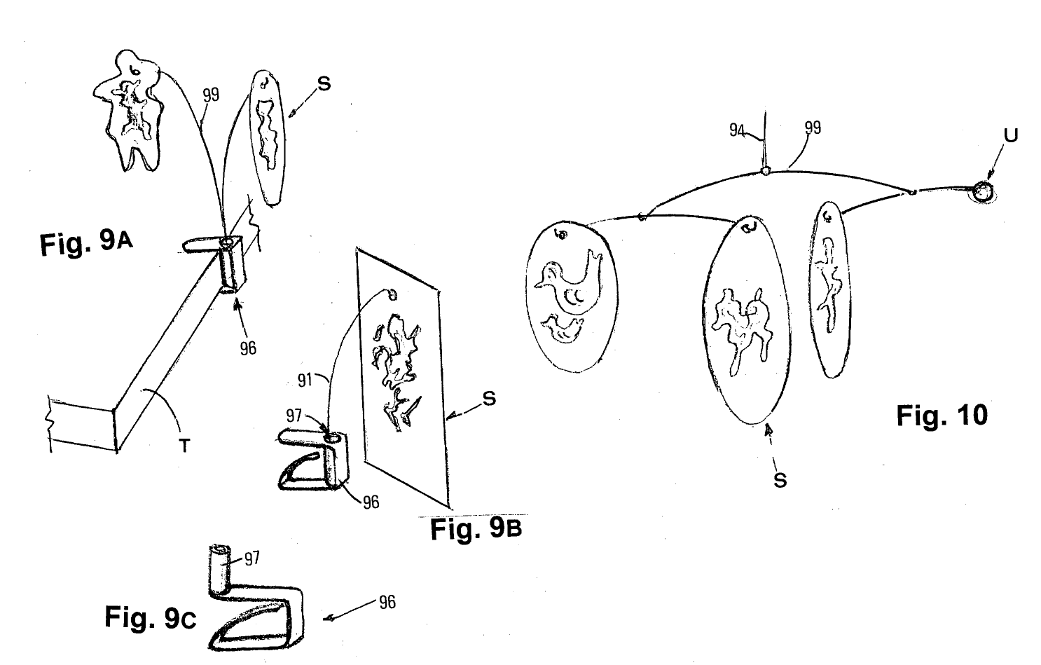

FIGS. 8A-8C, 9A-9C and 10 show further embodiments and uses of a structure according to the invention and, in particular, FIG. 8 is a partial perspective view of a suspended ornamental structure in two possible applications for the glass of a window, FIG. 8B is a lateral view relevant to an application of the previous figure, FIG. 8C is a perspective view of a support element for holding the structure, FIG. 9A is a partial perspective view of a suspended ornamental structure associable to a table, FIG. 9B is a perspective view relevant to an application similar to the one of the previous figure, FIG. 9C is a perspective view of a support element for holding the structure in association to a table, FIG. 10 is a perspective view of a possible example of a suspended structure with many arms.

With reference to the examples shown in FIGS. 1A-1D, 2A-2B, 3A-3C, 4A-4C, 5A-5D, 6A-6H, 7A-7J, 8A-9B, 9A-9B, 10 of the attached drawings, a structure according to the invention comprises:

a first element 1, for example made of cardboard, plastics or other suitable material, on which an aperture 2 is formed whose outline defines a predetermined geometric or fancy figure;

a flap or patch of fabric or cloth 3 applied on the rear surface 10 of said first element 1;

a second element 4 applied on the rear surface 10 of said first element 1 on the back of fabric 3, so that the fabric will result interposed between the first element 1 and the second element 4.

Said first and second elements 1, 4 may form one body, as they are joined in correspondence of a fold of same body, as illustrated in the examples of FIGS. 1A-1D, 2A-2B, 3A-3C.

Alternatively, the two elements 1 and 4 may also be separated at first, to be associated by gluing when forming the structure.

The second element 4 of the structure may, in turn, be joined to a third element 5 in correspondence of a fold 45 of said one body. The said folds 1, 45 define two axes of hinge-like connection between said elements 1, 4 and 4, 5, thereby allowing them to be opened/closed like a book when assembling the structure or during its use.

The cloth 3 is loosely applied on the back of the first element 1, or is sufficiently elastic as to partially coming out through the shaped aperture 2 when pushed from the back.

The second element 4 may be provided, in turn, with one or more apertures. In the example of FIGS. 1A-1D, the second element 4 is provided with only one central aperture 40 which allows simple animation games to be performed, as shown in FIG. 1D, by pushing the cloth from the back by the fingers of one hand. In the example of FIGS. 2A-2B and 3A-3B, the second element 4 is provided with more apertures 41 which, in the whole, can define one or more words (greetings, for example) or one or more figures intended to result inside the area delimited by the aperture 2 of the first element 1 and viewable against the light through the cloth 3, thereby completing and enriching the figure defined by said aperture 2 and cloth 3.

In the example illustrated in FIGS. 3A-3C, the said third element 5 exhibits a mirror-like reflecting surface 50 in which the cloth 3 and FIG. 42 reflect by filtering against the light through the fabric. As shown in the example of FIGS. 4A-4C, the structure (S) according to the invention is removably associated with a greetings card 6 in correspondence of a perforated or pre-cut line of connection 60 allowing it to be detached by hand, and is provided with a ribbon or cord 61 by means of which it can be suspended (for example, at a branch of a Christmas tree) for decorative purpose.

In the example relating to FIGS. 5A-5D, a structure is shown to be used, for example, for containing small objects such as sweets and small cakes 7 which, upon closing the package thus made, push the cloth 3 from the inside by causing an irregual, that is, casual swelling thereof. More envelopes of this kind can be easily put on display-stands 8 provided with relevant slits 80 which define receiving seats. A possible example of embodiment of the structure illustrated in FIGS. 5A-5D may be provided with a single front element 1 having two apertures 2, and a single rear element 4 provided with two corresponding apertures 40 having the same shape as the apertures 2. In particular, the apertures reproduce two human profiles. Provided between the two elements 1 and 4 is the cloth 3 which, as previously stated, defines, in closed condition, a kind of small bag for holding sweets 7. Numeral 140 designates a central folding line which subdivides the structure into two equal parts.

Shown in FIGS. 6A-6H are further embodiments and uses of a structure according to the invention.

In particular, FIG. 6A shows a small shoulder-bag, while FIG. 6B shows a cellular case; in these examples, the structure S of the present invention may form the front face of the objects. In FIGS. 6C and 6E there are shown two boxes having a lid defined by the structure S. The structure S is also able to make up a bookmarker, as shown in FIG. 6D, a belt as shown in FIG. 6F in which the structure is in correspondence of the buckle, the cover of a book like in FIG. 6G or a key case, like in FIG. 6H.

FIGS. 7A-7J show further embodiments and uses of structure according to the invention, which relate in particular to games. In FIG. 7A, the structure according to the invention makes up a poster for board games. In FIG. 7B a chessboard is shown with exemplary forms of chess 81 and draught 82. FIG. 7C shows a mask; in the left drawing, the mask is seen from the front side, while on the right side a perspective views shows the same mask when put on. FIG. 7D shows a dominoes game, FIGS. 7E, 7F, 7G some puzzle-type games, FIG. 7H a game with characters to be guessed (for example by keeping the eyes closed and using the touch) and, finally, FIGS. 7I and 7J show two game cards also made according to the present invention.

FIGS. 8A is a partial perspective view of a suspended ornamental structure in two possible applications for the glass G of a window. The structure showed on left has a support element constituted by a sucker 90, fixable to the surface of the glass G, and a simple support arm 91. It is possible to suspend the structure S realized according to the present invention at the free end of the arm 91. The structure on right has a composite support arm 99. It is possible to suspend many structures S (two in the example) at the arm 99. FIG. 8B is a lateral view relevant to the application of left, while FIG. 8C is a perspective view of a support element for holding the structure.

FIG. 9A is a partial perspective view of a suspended ornamental structure associable to a table T; in this example there is a multiple arm 99 that holds two structures S and the association to the table is performed by an elastic clamp 96. The elastic clamp can be realized in different ways, for example as shown in FIGS. 9A-9B: in these examples there is a different positioning of the seat 97 for the support arm of the suspended structure.

FIG. 10 is a perspective view of a possible example of a suspended structure with many arms; in this embodiment, there are not only the structures S but also a counterpoise U. This embodiment can be suspended from a ceiling, i.e. by a string 94.

Said first and second elements 1, 4 of the present structure need not to be equal to each other, as their shape and dimensions can be different from each other.

1. Structure with variable geometric pattern and appearance, especially, although not exclusively, for use in making stationery or publishing articles, as well as envelopes or packages, characterized in that it comprises:
a first element (1) having an aperture (2) whose outline defines a preset geometric or fancy figure;
a flap or patch of fabric or cloth (3) applied on the rear surface (10) of said first element (1);
a second element (4) associated with the rear surface of said first element (1) on the back of said fabric (3) so that the said fabric will result interposed between the first (1) and second (4) elements, the same fabric being able to partly project from the surface defined by said first element (1) or said second element (4), the surface of the latter being either continuous or provided, likewise the surface of the first element (1), with one or more apertures.

2. Structure according to claim 1, characterized in that the said fabric (3) is left loose, that is, not stretched, in correspondence of said aperture (2).

3. Structure according to claim 1, characterized in that the said fabric (3) is elastic.

4. Structure according to claim 1, characterized in that the said first and second elements (1, 4) consists of one body, as they are joined in correspondence of a fold (14) of said body being defined by same elements.

5. Structure according to claim 1, characterized in that the said first and second elements (1, 4) are made separate from each other and associated with each other upon making the structure.

6. Structure according to claim 1, characterized in that the said second element (4) of the structure is, in turn, united to a third element (5).

7. Structure according to claim 6, characterized in that the said second and third elements (4, 5) consist of one body, as they are joined in correspondence of a fold (45) of said body being defined by same elements.

8. Structure according to claim 6, characterized in that the said second and third elements (4, 5) are made separate from each other and associated with each other upon making the structure.

9. Structure according to claim 1, characterized in that the said second element (4) is, in turn, provided with one or more apertures (40; 41).

10. Structure according to claim 9, characterized in that the said one or more apertures (40; 41) define one or more writings and/or figures intended to result inside the area delimited by said aperture (2) and visible against the light through the cloth (3).

11. Structure according to claim 6, characterized in that the said third element (5) has a mirror-like reflecting surface (50).

12. Structure according to claim 1, characterized in that the structure (S) according to the invention is removably associated with a greeting card (6) in correspondence of a perforated or pre-cut connection line (60) allowing it to be detached by hand, and is provided with a ribbon or cord (61) by means of which it can be suspended.

13. Structure according to claim 1, characterized in that the said first front element (1) is provided with two apertures (2) symmetrically disposed with respect to a hinge axis (140), and said second rear element (4) is provided with two corresponding apertures (40) shaped likewise the apertures (2) of the first element, said apertures (2, 40) being so disposed as to coincide with each other when the structure (S) is in closed condition, that is, folded over about said axis (140).
